(19) United States
(12) Patent Application Publication
(10) Pub. No.: US 2025/0175740 A1
(43) Pub. Date: May 29, 2025

(54) VOICE PROCESSING SYSTEM, VOICE PROCESSING METHOD, AND NON-TRANSITORY COMPUTER-READABLE MEDIUM

(71) Applicant: SHARP KABUSHIKI KAISHA, Osaka (JP)

(72) Inventor: TATSUYA NISHIO, Osaka (JP)

(21) Appl. No.: 18/958,142

(22) Filed: Nov. 25, 2024

(30) Foreign Application Priority Data
Nov. 27, 2023 (JP) 2023-199606

(51) Int. Cl. H04R 3/12; H04R 3/00

(52) U.S. Cl. CPC H04R 3/12; H04R 3/005; H04R 2430/01

(57) ABSTRACT

A voice processing system controls voices of a plurality of voice devices arranged in a same space. The voice processing system includes: an acquisition processor that acquires a first voice input to a microphone of a first voice device; and a setting processor that enables or disables a function of outputting the first voice from speakers of one or more other second voice devices for each of the second voice devices.

### CROSS-REFERENCE TO RELATED APPLICATION

The present application claims priority from Japanese Application JP2023-199606, the content of which is hereby incorporated by reference into this application.

### BACKGROUND OF THE INVENTION

### 1. Field of the Invention

The present disclosure relates to a technique in which a plurality of users individually use voice devices in the same space to have a conversation.

### 2. Description of the Related Art

Conventionally, a system in which each of a plurality of users uses a voice device including a microphone and a speaker to be able to have a conversation has been known. For example, a system that includes a plurality of voice devices (personal communication devices) and a hub device installed in a meeting space and capable of simultaneously connecting the plurality of voice devices via a local network, and that constructs a group communication network in which the hub device enables the voice devices that have been connected to perform mutual simultaneous communication has been known.

### SUMMARY OF THE INVENTION

When a plurality of users individually use voice devices in the same space (such as a meeting room), the following problems occur. For example, when a first user uses an earphone-type voice device, a voice uttered by a second user in the same space is not reproduced from a speaker of the voice device, and ears are closed by the voice device. Therefore, the first user has difficulty in listening to the voice uttered by the second user. In addition, when the first user uses a desktop-type voice device, although the first user can directly listen to the voice uttered by the second user in the same space, the voice of the second user is reproduced from the voice device of the first user. Therefore, the voice is doubly heard. As described above, when a plurality of users individually use voice devices in the same space, a problem such as a decrease in conversation quality occurs.

An object of the present disclosure is to provide a voice processing system, a voice processing method, and a non-transitory computer-readable medium capable of improving the conversation quality when a plurality of users individually use voice devices in the same space to have a conversation.

A voice processing system according to one aspect of the present disclosure is a system that controls voices of a plurality of voice devices arranged in the same space. The voice processing system includes an acquisition processor and a setting processor. The acquisition processor acquires a first voice input to a microphone of a first voice device. The setting processor enables or disables a function of outputting the first voice from speakers of one or more other second voice devices for each of the second voice devices.

A voice processing method according to another aspect of the present disclosure is a method for controlling voices of a plurality of voice devices arranged in the same space, and one or more processors execute: acquiring a first voice input to a microphone of a first voice device; and enabling or disabling a function of outputting the first voice from speakers of one or more other second voice devices for each of the second voice devices.

A non-transitory computer-readable medium according to another aspect of the present disclosure stores a voice processing program that controls voices of a plurality of voice devices arranged in the same space, and the voice processing program causes one or more processors to execute: acquiring a first voice input to a microphone of a first voice device; and enabling or disabling a function of outputting the first voice from speakers of one or more other second voice devices for each of the second voice devices.

According to the present disclosure, a voice processing system, a voice processing method, and a non-transitory computer-readable medium capable of improving the conversation quality when a plurality of users individually use voice devices in the same space to have a conversation can be provided.

### BRIEF DESCRIPTION OF THE DRAWINGS

FIG. 1 is a diagram illustrating an application example of a voice processing system according to an embodiment of the present disclosure.

FIG. 2 is a diagram illustrating a configuration of the voice processing system according to the embodiment of the present disclosure.

FIG. 3A is a diagram illustrating an example of loopback registration information used in the voice processing system according to the embodiment of the present disclosure.

FIG. 3B is a diagram illustrating an example of the loopback registration information used in the voice processing system according to the embodiment of the present disclosure.

FIG. 4 is a diagram illustrating an example of a loopback registration screen displayed on the voice processing system according to the embodiment of the present disclosure.

FIG. 5A is a diagram illustrating an example of the loopback registration information used in the voice processing system according to the embodiment of the present disclosure.

FIG. 5B is a diagram illustrating an example of the loopback registration information used in the voice processing system according to the embodiment of the present disclosure.

FIG. 6A is a diagram illustrating an example of usage type registration information used in the voice processing system according to the embodiment of the present disclosure.

FIG. 6B is a diagram illustrating an example of the usage type registration information used in the voice processing system according to the embodiment of the present disclosure.

FIG. 7 is a diagram illustrating an example of a usage type registration screen displayed on the voice processing system according to the embodiment of the present disclosure.

FIG. 8A is a diagram illustrating an example of the usage type registration information used in the voice processing system according to the embodiment of the present disclosure.

FIG. 8B is a diagram illustrating an example of the usage type registration information used in the voice processing system according to the embodiment of the present disclosure.

FIG. 9A is a diagram illustrating an example of device type registration information used in the voice processing system according to the embodiment of the present disclosure.

FIG. 9B is a diagram illustrating an example of the device type registration information used in the voice processing system according to the embodiment of the present disclosure.

FIG. 10 is a diagram illustrating an example of a device type registration screen displayed on the voice processing system according to the embodiment of the present disclosure.

FIG. 11A is a diagram illustrating an example of the device type registration information used in the voice processing system according to the embodiment of the present disclosure.

FIG. 11B is a diagram illustrating an example of the device type registration information used in the voice processing system according to the embodiment of the present disclosure.

FIG. 12 is a diagram schematically illustrating an application example of a voice processing device according to Example 1 of the present disclosure.

FIG. 13 is a flowchart for describing an example of a procedure of voice control processing executed in the voice processing device according to Example 1 of the present disclosure.

FIG. 14 is a diagram schematically illustrating an application example of a voice processing device according to Example 2 of the present disclosure.

FIG. 15 is a flowchart for describing an example of a procedure of voice control processing executed in the voice processing device according to Example 2 of the present disclosure.

FIG. 16 is a diagram schematically illustrating an application example of a voice processing device according to Example 3 of the present disclosure.

### DETAILED DESCRIPTION OF THE INVENTION

Hereinafter, an embodiment of the present disclosure will be described with reference to the accompanying drawings. The following embodiment is merely an example that embodies the present disclosure, and does not intend to limit the technical scope of the present disclosure.

A voice processing system according to the present disclosure can be applied to, for example, a case where each of a plurality of users in the same space (for example, a meeting room) uses a voice device including a microphone and a speaker to have a conversation (conduct a meeting) with a user in another space. The voice processing system can also be applied to a case where each of a plurality of users uses a voice device to have a conversation in one space.

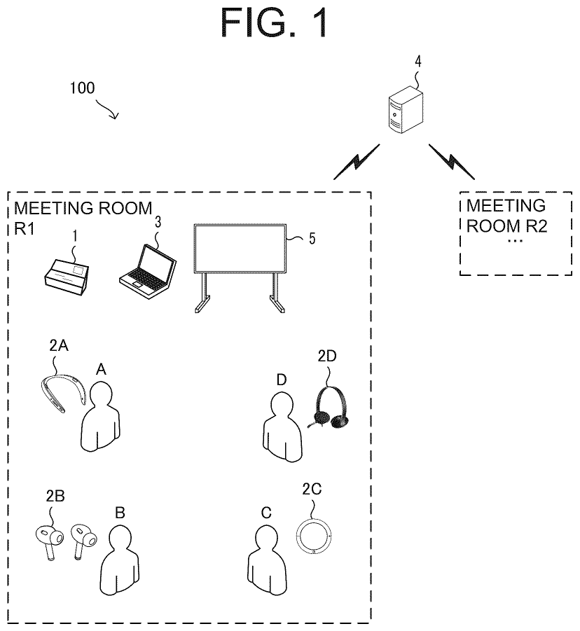

FIG. 1 illustrates an application example of a voice processing system 100 according to the present embodiment. As illustrated in FIG. 1, users A to D participate in a meeting in a meeting room R1, and another user (not illustrated) participates in the meeting in a meeting room R2. The user A uses a neckband-type voice device 2A which can be worn on the neck, the user B uses an earphone-type (inner-type) voice device 2B which can be inserted into the ears, the user C uses a desktop-type voice device 2C which is used with being placed on a desk, and the user D uses a headset-type voice device 2D which can be worn so as to cover the entire ears to have a conversation. The user in the meeting room R2 may use the voice device 2, or may use one microphone speaker device installed in the meeting room R2.

Each voice device 2 in the meeting room R1 is wirelessly connected (connected by Bluetooth (registered trademark)) to a voice processing device 1, and a voice input to the microphone of each voice device 2 is output (reproduced) from the speaker of the voice device 2 of the user (or the microphone speaker device) in the meeting room R2 via a meeting terminal 3 and a meeting server 4. The voice input to the microphone of the voice device 2 (or the microphone speaker device) in the meeting room R2 is output from the speaker of the voice device 2 of each user in the meeting room R1 via the meeting server 4 and the meeting terminal 3.

As described above, the voice processing system 100 is a system that enables a plurality of users to have a conversation in the same space (the meeting room R1 in FIG. 1) by individually using the voice devices 2. The voice processing system 100 may include a display device 5 which can be used in the meeting. The display device 5 displays meeting information such as camera images and meeting documents of meeting participants using a meeting application of the meeting server 4.

As illustrated in FIG. 1, the voice processing system 100 includes the voice processing device 1, the voice device 2, the meeting terminal 3, and the meeting server 4. The voice device 2 is a sound device with a wireless connection system, which is equipped with a microphone and a speaker. The microphone may be omitted from the voice device 2. The voice device 2 may have a function of, for example, an AI speaker or a smart speaker. The voice processing system 100 is a system that includes a plurality of voice devices 2 and transmits and receives voice data of uttered voices of users to and from the plurality of voice devices 2. The voice processing system 100 is an example of the voice processing system of the present disclosure.

The voice processing device 1 controls voices (input voices, output voices, and the like) of the voice devices 2, and executes processing of transmitting and receiving voices to and from the plurality of voice devices 2 when a meeting is started in a meeting room, for example. For example, the voice processing device 1 controls the plurality of voice devices 2 arranged in the same space. The voice processing device 1 alone may constitute the voice processing system of the present disclosure. When the voice processing system of the present disclosure is constituted by the voice processing device 1 alone, the voice processing device 1 may accumulate voices acquired from the voice devices 2 as voices for recording, and may execute processing of recognizing the acquired voices within the device itself (voice recognition processing).

In addition, the voice processing system of the present disclosure may include various servers that provide various services such as a meeting service, a subtitle service by voice recognition, a translation service, and a minutes service. In the present embodiment, the meeting server 4 that provides a meeting service is included. The meeting server 4 provides an online meeting service of a meeting application which is one of general-purpose software. For example, the meeting application is installed in the meeting terminal 3. By starting up the meeting terminal 3 and logging in, an online meeting (for example, an online meeting in the meeting room R1 and the meeting room R2) using the meeting application can be conducted.

### Voice Processing Device 1

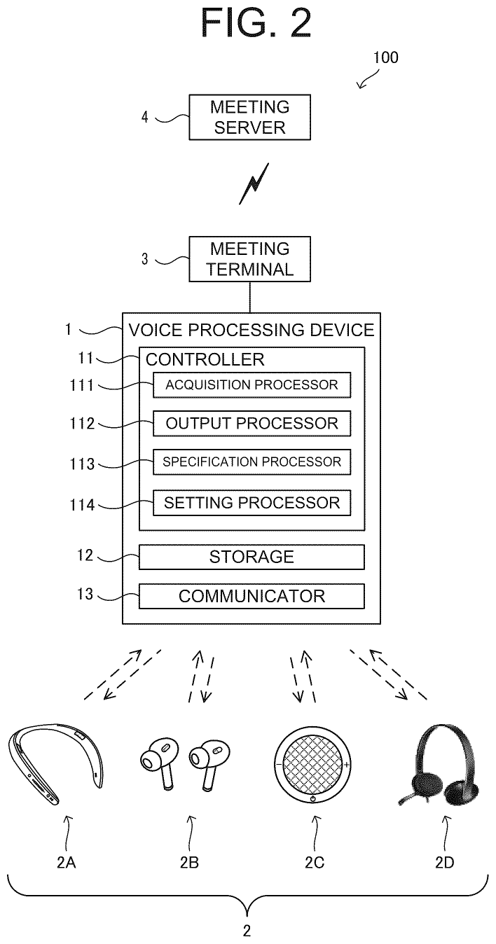

As illustrated in FIG. 2, the voice processing device 1 is a device including a controller 11, a storage 12, a communicator 13, and the like.

For example, the voice processing device 1 is constituted by a device including a function of transmitting and receiving voices and a function of mixing or splitting voices (for example, a mixer box).

The communicator 13 is a communicator for connecting the voice processing device 1 to a communication network in a wired or wireless manner, and executing data communication according to a predetermined communication protocol with external devices such as the voice devices 2 and the meeting terminal 3 (refer to FIG. 1) via the communication network. For example, the communicator 13 executes pairing processing by the Bluetooth method, and is wirelessly connected to each voice device 2.

The storage 12 is a non-volatile storage such as a hard disk drive (HDD), a solid state drive (SSD), or a flash memory, which stores various types of information. Specifically, the storage 12 stores data such as loopback registration information D1 regarding setting registration of a loopback reproduction function for each voice device 2 connected to the voice processing device 1, usage type registration information D2 regarding the usage type for each voice device 2, and device type registration information D3 regarding the type for each voice device 2.

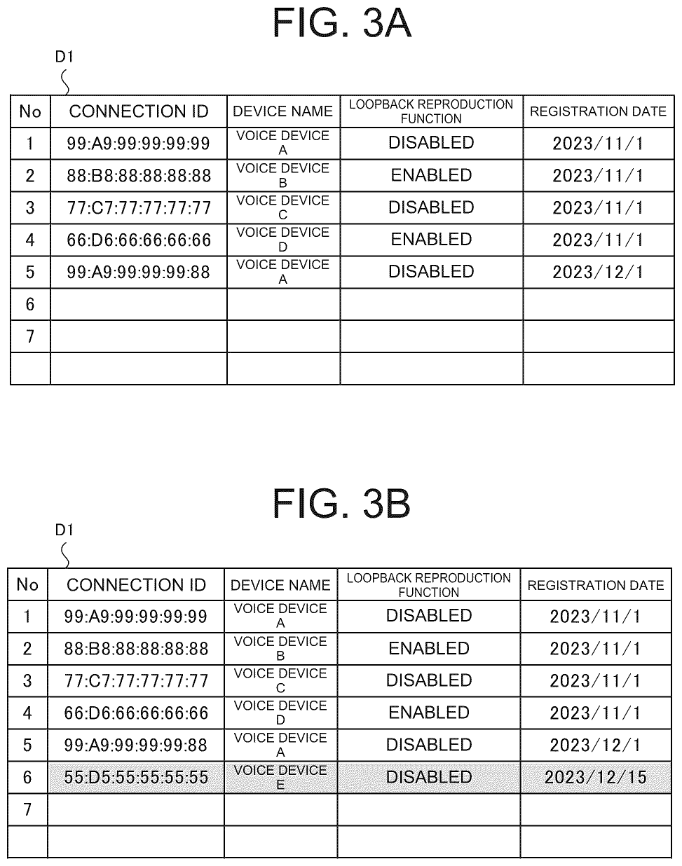

FIG. 3A illustrates an example of the loopback registration information D1. As illustrated in FIG. 3A, the loopback registration information D1 includes information such as “connection ID,” “device name,” “loopback reproduction function,” and “registration date.” The connection ID is identification information to be used when the voice deice 2 is connected, and is, for example, a Bluetooth address. The device name is a device name of the voice device 2. Instead of the device name, a model name may be registered. The loopback reproduction function is a function of outputting a voice input to a microphone of one voice device 2 from a speaker of another voice device 2 in a plurality of voice devices 2 arranged in the same space. In the loopback registration information D1, setting information of the loopback reproduction function (“disabled” or “enabled”) is registered for each voice device 2. Moreover, in the loopback registration information D1, a registration date of the setting information of the loopback reproduction function is registered.

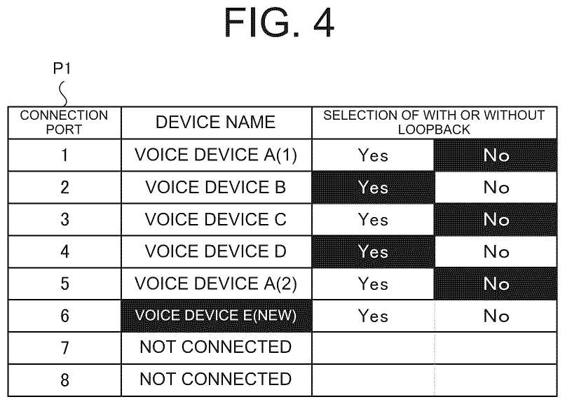

The loopback reproduction function is registered by, for example, a user operation. For example, on a loopback registration screen P1 illustrated in FIG. 4, the user selects whether to enable (“Yes”) or disable (“No”) the loopback reproduction function for the voice device 2 connected to a connection port of the voice processing device 1. For the voice device 2 for which “enabled” or “disabled” has already been registered, the controller 11 displays the registered information on the loopback registration screen P1. As illustrated in FIG. 4, when the voice device 2 (“voice device E”) is newly connected to the connection port “6,” the controller 11 receives a selection operation of “Yes” or “No” from the user. The controller 11 registers the setting information of the loopback reproduction function (“disabled” or “enabled”) in the loopback registration information D1 on the basis of the selection operation of the user. FIG. 3A illustrates the loopback registration information D1 before the information of the “voice device E” is registered, and FIG. 3B illustrates the loopback registration information D1 after the information of the “voice device E” is registered.

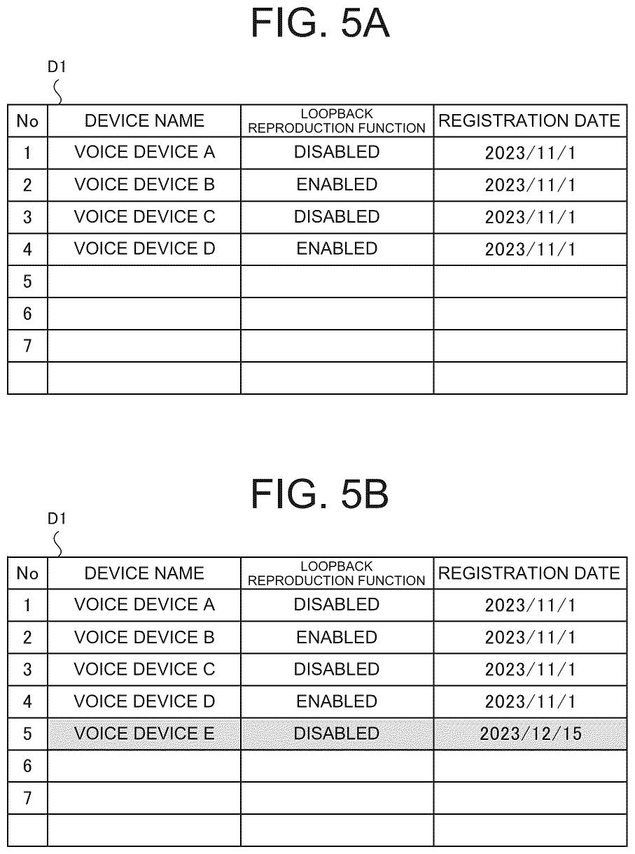

In FIG. 3A and FIG. 3B, the loopback registration information D1 is configured to manage the setting information of the loopback reproduction function by the connection ID. However, as another embodiment, as illustrated in FIG. 5A and FIG. 5B, the loopback registration information D1 may be configured to manage the setting information of the loopback reproduction function by the device name.

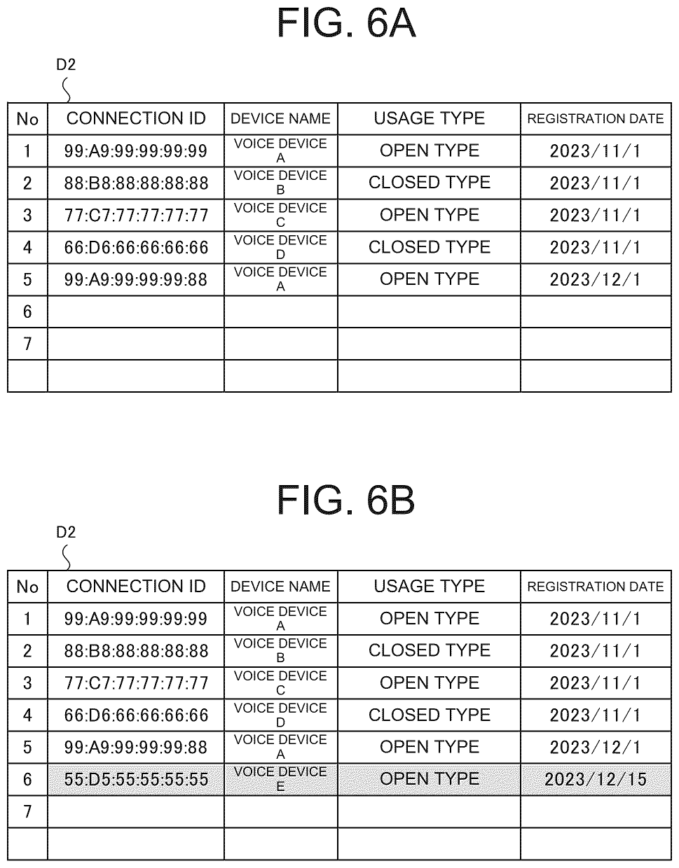

FIG. 6A illustrates an example of the usage type registration information D2. As illustrated in FIG. 6A, the usage type registration information D2 includes information such as “connection ID,” “device name,” “usage type,” and “registration date.” The usage type is information indicating the type related to a method of using the voice device 2, and includes, for example, a closed type in which ears are closed during use, an open type in which ears are not closed during use, and the like. For example, the neckband-type voice device 2A and the desktop-type voice device 2C do not close the ears of the user during use, and thus the usage type is the “open type.” In contrast, the earphone-type (inner-type) voice device 2B and the headset-type voice device 2D close the ears of the user during use, and thus the usage type is the “closed type.” In the usage type registration information D2, the usage type (“open type” or “closed type”) is registered for each voice device 2. Moreover, in the usage type registration information D2, a registration date of the usage type is registered.

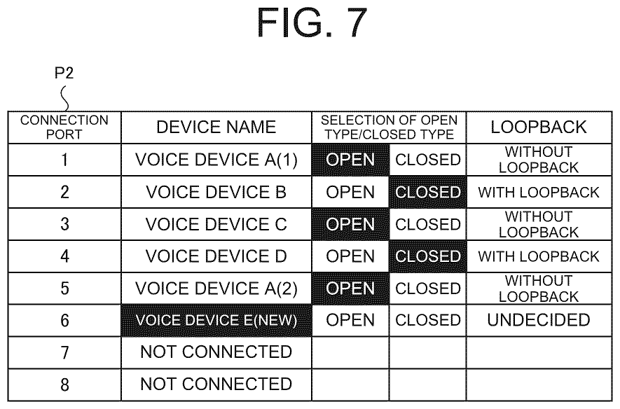

The usage type is registered by, for example, a user operation. For example, on a usage type registration screen P2 illustrated in FIG. 7, the user selects the usage type (“open” or “closed”) for the voice device 2 connected to the connection port of the voice processing device 1. For the voice device 2 for which the usage type has already been registered, the controller 11 displays the registered information on the usage type registration screen P2. Moreover, the controller 11 may automatically display the setting information of the loopback reproduction function in accordance with the usage type selected by the user. For example, the controller 11 displays “without loopback” (disabled) when the usage type is “open type,” and displays “with loopback” (enabled) when the usage type is “closed type.”

As illustrated in FIG. 7, when the voice device 2 (“voice device E”) is newly connected to the connection port “6,” the controller 11 receives a selection operation of “open” or “closed” from the user. The controller 11 registers the usage type (“open type” or “closed type”) in the usage type registration information D2 on the basis of the selection operation of the user. FIG. 6A illustrates the usage type registration information D2 before the information of the “voice device E” is registered, and FIG. 6B illustrates the usage type registration information D2 after the information of the “voice device E” is registered.

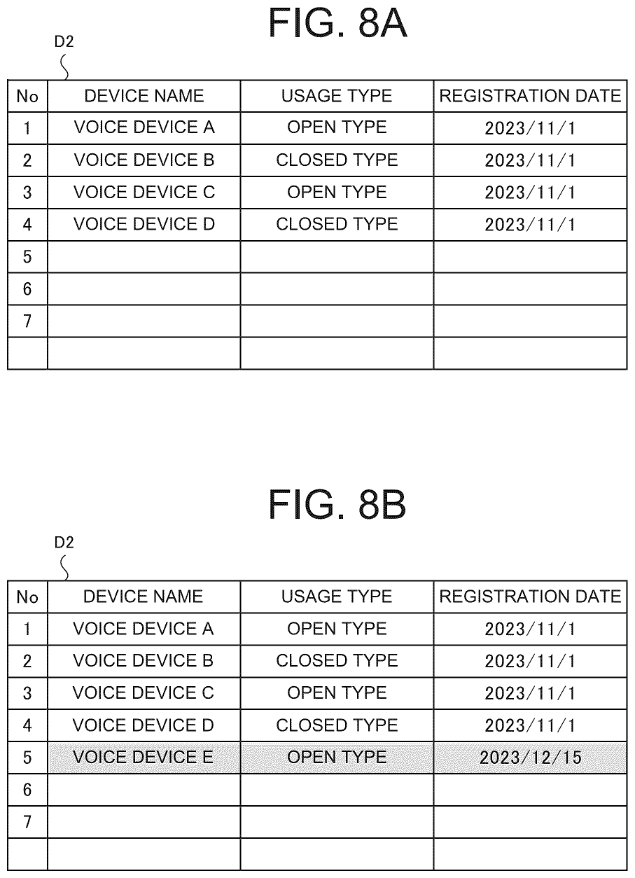

In FIG. 6A and FIG. 6B, the usage type registration information D2 is configured to manage the registration information of the usage type by the connection ID. However, as another embodiment, as illustrated in FIG. 8A and FIG. 8B, the usage type registration information D2 may be configured to manage the registration information of the usage type by the device name.

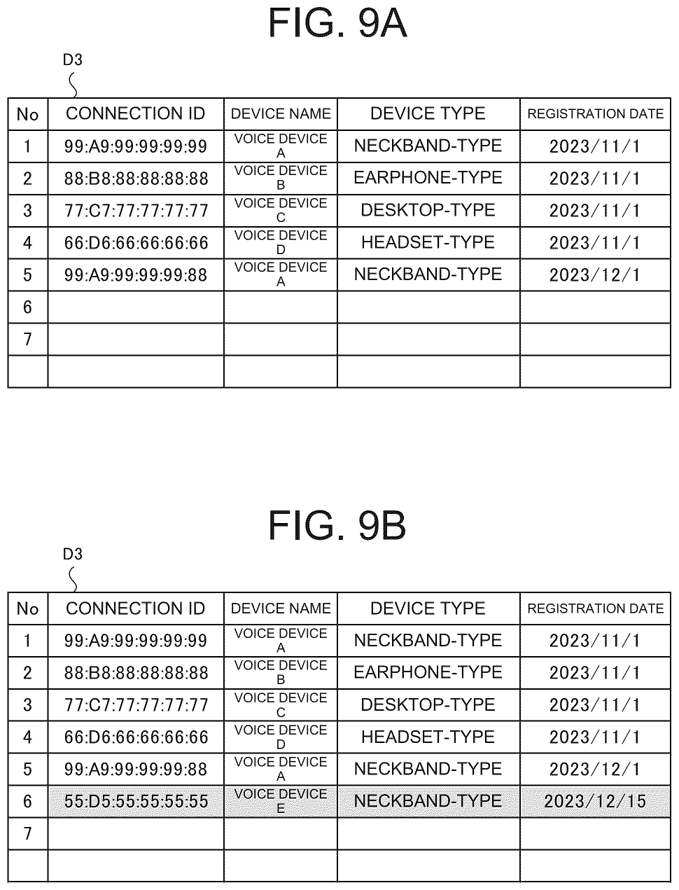

FIG. 9A illustrates an example of the device type registration information D3. As illustrated in FIG. 9A, the device type registration information D3 includes information such as “connection ID,” “device name,” “device type,” and “registration date.” The device type is information indicating the type of the voice device 2, and includes, for example, “neckband-type,” “earphone-type,” “desktop-type,” “headset-type,” and the like. In the device type registration information D3, the device type (“neckband-type,” “earphone-type,” “desktop-type,” or “headset-type”) is registered for each voice device 2. Moreover, in the device type registration information D3, a registration date of the device type is registered.

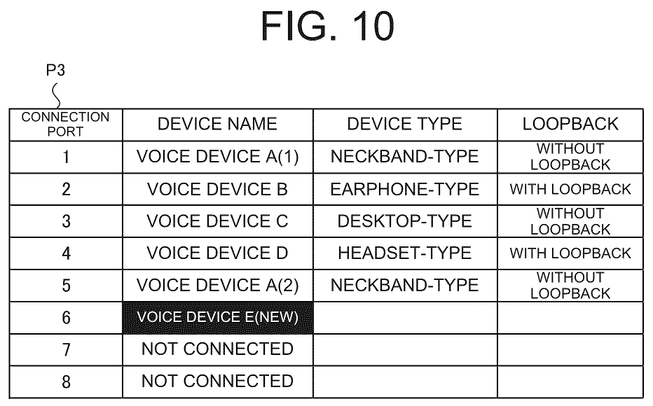

The device type is registered by, for example, a user operation. For example, on a device type registration screen P3 illustrated in FIG. 10, the user selects the device type (“neckband-type,” “earphone-type,” “desktop-type,” or “headset-type”) for the voice device 2 connected to the connection port of the voice processing device 1. For the voice device 2 for which the device type has already been registered, the controller 11 displays the registered information on the device type registration screen P3. Moreover, the controller 11 may automatically display the setting information of the loopback reproduction function in accordance with the device type selected by the user. For example, the controller 11 displays “without loopback” (disabled) when the device type is “neckband-type” or “desktop-type,” and displays “with loopback” (enabled) when the device type is “earphone-type” or “headset-type.”

As illustrated in FIG. 10, when the voice device 2 (“voice device E”) is newly connected to the connection port “6,” the controller 11 receives a selection operation of “neckband-type,” “earphone-type,” “desktop-type,” or “headset-type” from the user. The controller 11 registers the device type (“neckband-type,” “earphone-type,” “desktop-type,” or “headset-type”) in the device type registration information D3 on the basis of the selection operation of the user. FIG. 9A illustrates the device type registration information D3 before the information of the “voice device E” is registered, and FIG. 9B illustrates the device type registration information D3 after the information of the “voice device E” is registered.

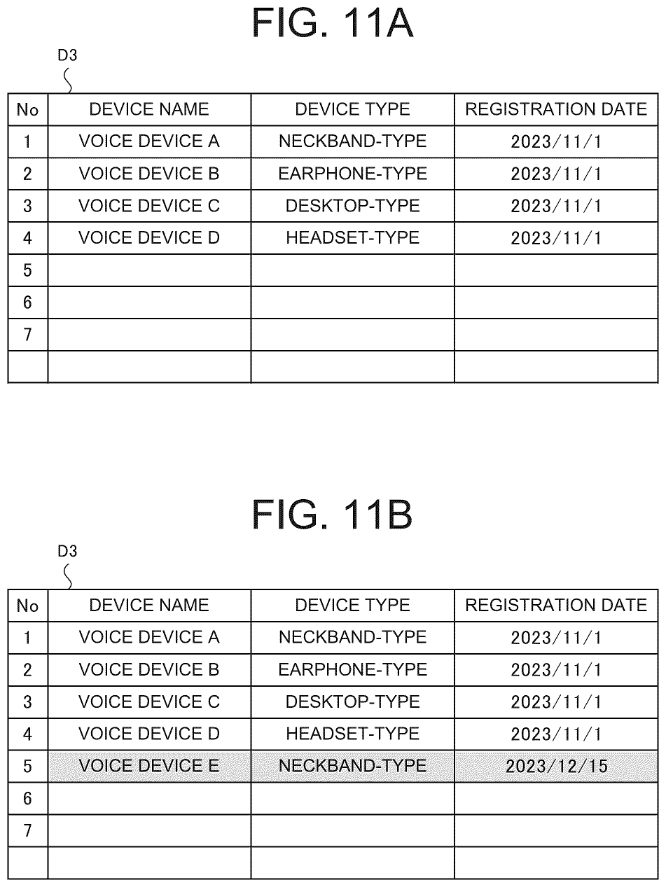

In FIG. 9A and FIG. 9B, the device type registration information D3 is configured to manage the registration information of the device type by the connection ID. However, as another embodiment, as illustrated in FIG. 11A and FIG. 11B, the device type registration information D3 may be configured to manage the registration information of the device type by the device name.

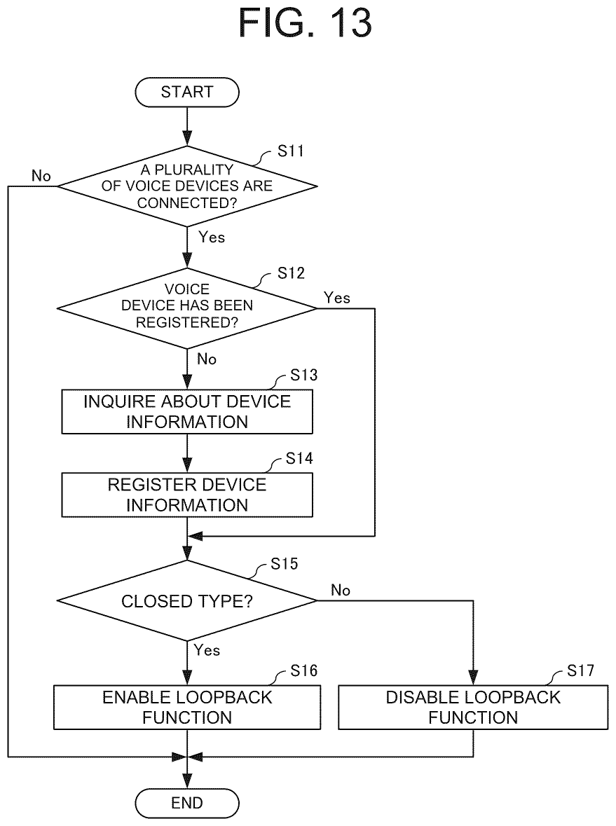

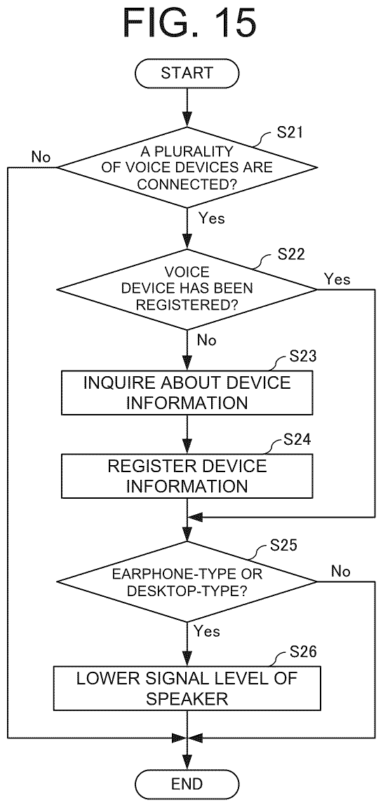

Moreover, the storage 12 stores a control program such as a voice control program (an example of a voice processing program of the present disclosure) for causing the controller 11 to execute voice control processing described below (refer to FIG. 13 and FIG. 15). For example, the voice control program may be recorded, in a non-transitory way, on a computer-readable recording medium such as a CD or a DVD, and be read by a reading device (not illustrated) such as a CD drive or a DVD drive provided in the voice processing device 1 to be stored in the storage 12.

The controller 11 has control devices such as a CPU, a ROM, and a RAM. The CPU is a processor that executes various types of arithmetic processing. The ROM is a non-volatile storage that stores in advance control programs such as a BIOS and an OS for causing the CPU to execute various types of arithmetic processing. The RAM is a volatile or non-volatile storage that stores various types of information, and is used as a transitory storage memory (work area) for various types of processing executed by the CPU. The controller 11 controls the voice processing device 1 by causing the CPU to execute the various control programs, which are stored in advance in the ROM or the storage 12.

Specifically, as illustrated in FIG. 2, the controller 11 includes various processors such as an acquisition processor 111, an output processor 112, a specification processor 113, and a setting processor 114. The controller 11 functions as the various processors by causing the CPU to execute various types of processing according to the control programs. In addition, some or all of the processors may be constituted by electronic circuits. The control programs may be programs for causing a plurality of processors to function as the processors.

The voice processing device 1 may include configurations described in Examples 1 to 3 below. Hereinafter, a specific configuration of each of Examples 1 to 3 will be described.

### Example 1

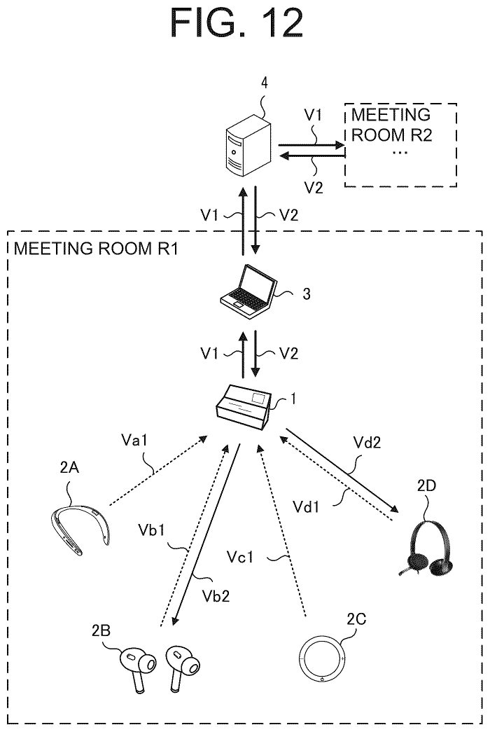

FIG. 12 schematically illustrates an application example of the voice processing device 1 according to Example 1. “Va1” in FIG. 12 indicates a voice uttered by a user A, input to the microphone of the voice device 2A, and output from the voice device 2A to the voice processing device 1. “Vb1” indicates a voice uttered by a user B, input to the microphone of the voice device 2B, and output from the voice device 2B to the voice processing device 1. “Vc1” indicates a voice uttered by a user C, input to the microphone of the voice device 2C, and output from the voice device 2C to the voice processing device 1. “Vd1” indicates a voice uttered by a user D, input to the microphone of the voice device 2D, and output from the voice device 2D to the voice processing device 1. “Vb2” indicates a voice (loopback voice) that is the voice Va1, Vc1, or Vd1 output from the voice processing device 1 to the voice device 2B. “Vd2” indicates a voice (loopback voice) that is the voice Va1, Vb1, or Vc1 output from the voice processing device 1 to the voice device 2D.

In addition, “V1” in FIG. 12 indicates a voice output from the voice processing device 1 in the meeting room R1 to the meeting server 4 via the meeting terminal 3, and output from the meeting server 4 to the voice processing device 1 in the meeting room R2. “V2” indicates a voice output from the voice processing device 1 in the meeting room R2 to the meeting server 4, and output from the meeting server 4 to the voice processing device 1 via the meeting terminal 3 in the meeting room R1.

The acquisition processor 111 of the controller 11 acquires a voice input to the microphone of the voice device 2. In the example illustrated in FIG. 12, the acquisition processor 111 acquires the uttered voice (voice Va1) of the user A from the voice device 2A, acquires the uttered voice (voice Vb1) of the user B from the voice device 2B, acquires the uttered voice (voice Vc1) of the user C from the voice device 2C, and acquires the uttered voice (voice Vd1) of the user D from the voice device 2D.

Moreover, the acquisition processor 111 acquires, via a network, a voice output from the meeting server 4 via the meeting terminal 3. For example, the acquisition processor 111 acquires the voice V2 uttered by a user in the meeting room R2 from the meeting server 4 via the meeting terminal 3.

The output processor 112 outputs a voice acquired by the acquisition processor 111. For example, the output processor 112 outputs the voice V1 (voices Va1 to Vd1) acquired from the voice device 2 in the meeting room R1 to the meeting server 4 via the meeting terminal 3. Moreover, the output processor 112 outputs the voice V2 acquired from the meeting server 4 to each voice device 2 in the meeting room R1. The output processor 112 is set so as not to output the voice input to the microphone of the voice device 2 itself from the speaker of the voice device 2 itself. For example, the voice input from the microphone of the voice device 2A is not output from the speaker of the voice device 2A.

The specification processor 113 specifies the type of the voice device 2. For example, the specification processor 113 specifies the usage type of the voice device 2 connected to the voice processing device 1 with reference to the information registered in the usage type registration information D2 (refer to FIG. 6A). Specifically, the specification processor 113 determines whether the voice device 2 is of a closed type in which the ears of the user are closed during use or of an open type in which the ears of the user are not closed during use. Moreover, for example, the specification processor 113 specifies the device type of the voice device 2 connected to the voice processing device 1 with reference to the information registered in the device type registration information D3 (refer to FIG. 9A). Specifically, the specification processor 113 determines whether the voice device 2 is of “neckband-type,” “earphone-type,” “desktop-type,” or “headset-type.” Furthermore, for example, the specification processor 113 specifies the setting information of the loopback reproduction function (“disabled” or “enabled”) of the voice device 2 connected to the voice processing device 1 with reference to the information registered in the loopback registration information D1 (refer to FIG. 3A). Specifically, the specification processor 113 determines whether the loopback reproduction function of the voice device 2 is set to be “enabled” or “disabled.”

When the usage type of the voice device 2 connected to the voice processing device 1 is not registered in the usage type registration information D2, the controller 11 inquires of the user about the usage type of the voice device 2 (refer to FIG. 7), and, when acquiring the usage type of the voice device 2, registers the usage type of the voice device 2 in the usage type registration information D2. Moreover, when the device type of the voice device 2 connected to the voice processing device 1 is not registered in the device type registration information D3, the controller 11 inquires of the user about the device type of the voice device 2 (refer to FIG. 10), and, when acquiring the device type of the voice device 2, registers the device type of the voice device 2 in the device type registration information D3. Furthermore, when the setting information of the loopback reproduction function (“disabled” or “enabled”) of the voice device 2 connected to the voice processing device 1 is not registered in the loopback registration information D1, the controller 11 inquires of the user about the setting information of the loopback reproduction function of the voice device 2 (refer to FIG. 4), and, when acquiring the setting information of the loopback reproduction function of the voice device 2, registers the setting information of the loopback reproduction function of the voice device 2 in the loopback registration information D1. The controller 11 may perform network search (Internet search) on the basis of the identification information of the voice device 2 to acquire information of the voice device 2 (the usage type, the device type, and the like) and register the acquired information.

In the example illustrated in FIG. 12, the specification processor 113 specifies the usage type (“open type” or “closed type”) of each of the voice devices 2A to 2D with reference to, for example, the usage type registration information D2. Here, the specification processor 113 specifies the voice devices 2A and 2C as “open type,” and specifies the voice devices 2B and 2D as “closed type.”

In a plurality of voice devices 2 arranged in the same space, the setting processor 114 enables or disables a function of outputting a voice input to a microphone of one voice device 2 from speakers of one or more other voice devices 2 (loopback function) for each of the other voice devices 2. Specifically, the setting processor 114 enables or disables the loopback function of the voice device 2 on the basis of the type of the voice device 2. That is, the specification processor 113 determines whether the voice device 2 is of the closed type or of the open type, and the setting processor 114 enables or disables the loopback function of the voice device 2 on the basis of the determination result of the type of the voice device 2 by the specification processor 113.

Here, “enabling the loopback function of the voice device 2” means that the output processor 112 causes the voice input to the microphone of one voice device 2 to be output from the speakers of one or more other voice devices 2. In addition, “disabling the loopback function of the voice device 2” means that the output processor 112 does not cause the voice input to the microphone of one voice device 2 to be output from the speakers of one or more other voice devices 2.

For example, the setting processor 114 enables the loopback function when the voice device 2 is of the closed type, and disables the loopback function when the voice device 2 is of the open type. When the setting processor 114 enables the loopback function of a predetermined voice device 2, the output processor 112 causes the voice input to the microphone of another voice device 2 to be output from the speaker of the predetermined voice device 2. In contrast, when the setting processor 114 disables the loopback function of a predetermined voice device 2, the output processor 112 does not cause the voice input to the microphone of another voice device 2 to be output from the speaker of the predetermined voice device 2.

In the example illustrated in FIG. 12, since the voice devices 2B and 2D are of the closed type, the setting processor 114 enables the loopback function of the voice devices 2B and 2D. In contrast, since the voice devices 2A and 2C are of the open type, the setting processor 114 enables the loopback function of the voice devices 2A and 2C. In this case, for example, when the user A utters, the output processor 112 outputs the voice Va1 of the user A to each of the voice devices 2B and 2D (corresponding to the voices Vb2 and Vd2), and outputs (reproduces) the voice Va1 from each of the speakers of the voice devices 2B and 2D. In contrast, the output processor 112 does not output the voice Va1 of the user A to the voice device 2C.

As described above, when the voice device 2 is connected, the setting processor 114 acquires the usage type associated with the identification information of the voice device 2 in advance, and enables or disables the loopback function of the voice device on the basis of the acquired usage type.

As a result, the user B and the user D, whose ears are closed by the voice devices 2B and 2D and who have difficulty in directly listening to the voice uttered by the user A, can listen to the uttered voice of the user A reproduced from each of the voice devices 2B and 2D. In contrast, the user C can directly listen to the uttered voice of the user A because his/her ears are not closed by the voice device 2C, and the uttered voice of the user A (Va1) is not reproduced from the voice device 2C, so that the uttered voice is not heard doubly.

When the voice device 2 is connected, the setting processor 114 may acquire the device type associated with the identification information of the voice device 2 in advance, and enable or disable the loopback function of the voice device on the basis of the acquired device type. Moreover, when the voice device 2 is connected, the setting processor 114 may acquire the setting information of the loopback reproduction function (“disabled” or “enabled”) associated with the identification information of the voice device 2 in advance, and enable or disable the loopback function of the voice device on the basis of the acquired setting information.

### Voice Control Processing

FIG. 13 illustrates an example of a procedure of voice control processing executed by the controller 11 of the voice processing device 1 according to Example 1.

The present disclosure can be regarded as a voice control method of executing one or more steps included in the voice control processing (a voice processing method of the present disclosure). Moreover, the one or more steps included in the voice control processing described herein may be appropriately omitted. Moreover, the order in which the steps of the voice control processing are executed may be varied as long as the same effect and advantage are produced. Furthermore, although a case where the controller 11 executes the steps of the voice control processing will be described herein as an example, in another embodiment, one or more processors may execute the steps of the voice control processing in a distributed manner.

A case where a user in the meeting room R1 connects (pairs) the voice device 2 to the voice processing device 1 and participates in a meeting will be described herein as an example.

First, in step S11, the controller 11 determines whether a plurality of voice devices 2 are connected. For example, the controller 11 determines whether a plurality of voice devices 2 are connected at the time of starting a meeting in the meeting room R1. When the controller 11 determines that a plurality of voice devices 2 are connected (S11: Yes), the controller 11 shifts the processing to step S12. In contrast, when the controller 11 determines that a plurality of voice devices 2 are not connected, that is, only one voice device 2 is connected (S11: No), the controller 11 ends the voice control processing.

When a plurality of voice devices 2 are connected, the controller 11 executes the following processing of steps S12 to S17 for each voice device 2. Specifically, in step S12, the controller 11 determines whether the device information of a target voice device 2 has been registered in the usage type registration information D2 (refer to FIG. 6A). When the controller 11 determines that the device information of the target voice device 2 has been registered in the usage type registration information D2 (S12: Yes), the controller 11 shifts the processing to step S15. In contrast, when the controller 11 determines that the device information of the target voice device 2 has not been registered in the usage type registration information D2 (S12: No), the controller 11 shifts the processing to step S13.

In step S13, the controller 11 inquires about the device information regarding the target voice device 2. For example, on the basis of the identification information of the voice device 2 acquired when the voice device 2 is connected, the controller 11 may perform network search (Internet search) or may require the user of the voice device 2 to perform an input operation of the device information of the voice device 2. For example, on the usage type registration screen P2 (refer to FIG. 7), the controller 11 receives an operation of selecting the usage type (“open” or “closed”) from the user.

In step S14, the controller 11 acquires and registers the device information of the target voice device 2. For example, the controller 11 acquires the usage type and registers the usage type in the usage type registration information D2 (refer to FIG. 6B). After registering the device information, the controller 11 shifts the processing to step S15.

In step S15, the controller 11 determines whether the type (usage type) of the target voice device 2 is the closed type. The controller 11 determines the usage type of the voice device 2 with reference to the usage type registration information D2. When the controller 11 determines that the target voice device 2 is of the closed type (S15: Yes), the controller 11 shifts the processing to step S16. In contrast, when the controller 11 determines that the target voice device 2 is of the open type (S15: No), the controller 11 shifts the processing to step S17.

In step S16, the controller 11 enables the loopback reproduction function of the target voice device 2. In the example illustrated in FIG. 12, since the voice devices 2B and 2D are of the closed type, the controller 11 enables the loopback function of the voice devices 2B and 2D.

In contrast, in step S17, the controller 11 disables the loopback reproduction function of the target voice device 2. In the example illustrated in FIG. 12, since the voice devices 2A and 2C are of the open type, the controller 11 disables the loopback function of the voice devices 2A and 2C.

In this way, the controller 11 determines whether to enable the loopback function for each of the voice devices 2A to 2D. When the setting of the loopback function is completed for each voice device 2, the controller 11 controls the output destination of the voice in the meeting. For example, the controller 11 outputs a voice uttered by a user in the meeting room R1 and acquired via the voice device 2 to the voice devices 2B and 2D in which the loopback function is enabled (the voices Vb2 and Vd2 in FIG. 12), and does not output the voice to the voice devices 2A and 2C in which the loopback function is disabled.

As another embodiment, when the device information of the target voice device 2 is not registered, the controller 11 may inquire about the setting of the loopback reproduction function (“disabled” or “enabled”). For example, on the loopback registration screen P1 (refer to FIG. 4), the controller 11 receives an operation of selecting whether to enable (“Yes”) or disable (“No”) the loopback reproduction function from the user. The controller 11 sets the loopback reproduction function of the target voice device 2 on the basis of the inquiry result (the selection operation of the user).

Moreover, as another embodiment, when the device information of the target voice device 2 is not registered, the controller 11 may inquire about the device type. For example, on the device type registration screen P3 (refer to FIG. 10), the controller 11 receives an operation of selecting the device type (“neckband-type,” “earphone-type,” “desktop-type,” or “headset-type”) from the user. The controller 11 sets the loopback reproduction function of the target voice device 2 on the basis of the inquiry result (the selection operation of the user).

The controller 11 registers the information selected by the user (the usage type, the device type, and the setting of the loopback reproduction function), and sets, when a voice device 2 is connected next time, the loopback reproduction function on the basis of the registration information corresponding to the voice device 2.

As described above, the voice processing device 1 according to Example 1 acquires a first voice input to a microphone of a first voice device 2, and enables or disables a function of outputting the first voice from speakers of one or more other second voice devices 2 (loopback function) for each of the second voice devices 2. Moreover, the voice processing device 1 specifies a type of each of the voice devices 2, and enables or disables the loopback function of a target second voice device of the second voice devices 2 on the basis of the type (closed type or open type) of the target second voice device.

According to the above-described configuration, it becomes possible to appropriately listen to the uttered voices of the users in the same space regardless of the type of the voice device 2 used by a user himself/herself, and thus the conversation quality can be improved.

As another embodiment, the setting processor 114 may enable or disable the loopback function for each of the voice devices 2 in accordance with a setting operation of the user.

As another embodiment, the loopback registration information D1, the usage type registration information D2, and the device type registration information D3 may be created outside the voice processing system 100 and downloaded to the voice processing device 1. In addition, the loopback registration information D1, the usage type registration information D2, and the device type registration information D3 may be regularly created files such as a text file and a csv file. Accordingly, by storing the information of the voice device 2 to be connected in the voice processing device 1 in advance, the setting at the time of the initial connection can be omitted.

### Example 2

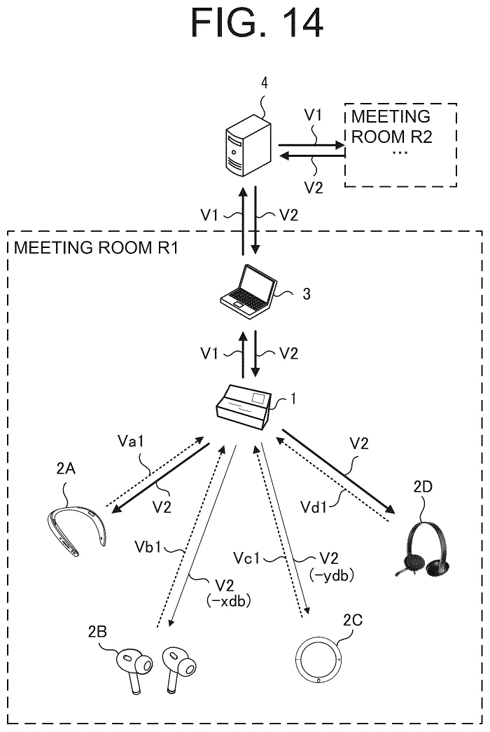

FIG. 14 schematically illustrates an application example of the voice processing device 1 according to Example 2. Example 2 has a configuration related to voice control in a case where a voice V2 uttered by a user in the meeting room R2 is output to the voice device 2 of a user in the meeting room R1.

For example, the earphone-type voice device 2B is inserted into the ears of the user, and thus becomes a burden on the ears when the speaker volume is high. In addition, the desktop-type voice device 2C causes discomfort to surrounding users when the speaker volume is high. As described above, an appropriate volume varies depending on the type of the voice device 2 used by the user.

Therefore, the setting processor 114 sets a signal level of the speaker of the voice device 2 on the basis of the type of the voice device 2. For example, the setting processor 114 lowers the signal level of the speaker of the voice device 2B by x decibels (x db), and lowers the signal level of the speaker of the voice device 2C by y decibels. The setting processor 114 may set the signal level of the speaker of the voice device 2B to be lower than the signal level of the speaker of the voice device 2C (for example, x>y).

In addition, the setting processor 114 may change the signal levels of the voice devices 2A and 2D. Moreover, as another embodiment, the setting processor 114 may set the signal level of each voice device 2 on the basis of a combination of the types of the plurality of voice devices 2 used in the same space.

Furthermore, the setting processor 114 may set the signal level for a voice by the loopback function (loopback voice) corresponding to Example 1. For example, in the voice devices 2B and 2D, the signal level of the voice to be output to the video device 2B having a higher degree of sealing may be set to a level lower than the signal level of the voice to be output to the video device 2D.

### Voice Control Processing

FIG. 15 illustrates an example of a procedure of voice control processing executed by the controller 11 of the voice processing device 1 according to Example 2. Since steps S21 to S24 illustrated in FIG. 15 are the same as steps S11 to S14 illustrated in FIG. 13 of Example 1, the description thereof will be omitted.

In step S25, the controller 11 determines whether the target voice device 2 is of the earphone-type or of the desktop-type. The controller 11 determines the usage type of the voice device 2 with reference to the usage type registration information D2 (refer to FIG. 6A). When the controller 11 determines that the target voice device 2 is of the earphone-type or of the desktop-type (S25: Yes), the controller 11 shifts the processing to step S26. In contrast, when the controller 11 determines that the target voice device 2 is of the neckband-type or of the headset-type (S25: No), the controller 11 ends the voice control processing.

In step S26, the controller 11 lowers the signal level of the speaker of the target voice device 2. In the example illustrated in FIG. 14, the controller 11 lowers the signal level of the speaker of the earphone-type voice device 2B by x decibels (x db), and lowers the signal level of the speaker of the desktop-type voice device 2C by y decibels.

In this way, the controller 11 sets the signal level of the speaker for each of the voice devices 2A to 2D. When the setting of the signal level of the speaker is completed for each voice device 2, the controller 11 controls each signal level for each voice device 2 when outputting a voice in the meeting.

According to the configuration of Example 2, a burden on the ears and discomfort to the surroundings due to an unnecessarily loud voice being output can be prevented.

### Example 3

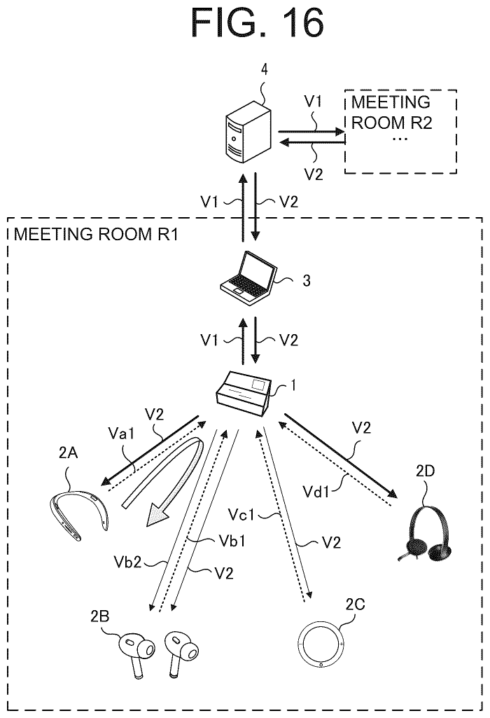

FIG. 16 schematically illustrates an application example of the voice processing device 1 according to Example 3. Example 3 is configured to control a voice output by the loopback function according to Example 1 and a voice V2 uttered by a user and output from the meeting room R2.

For example, when a signal level at which an uttered voice of the user A (voice Va1) output by the loopback function is input to the voice device 2B of the user B (voice Vb2) and output from the speaker is different from a signal level at which a voice V2 uttered by a user in the meeting room R2 is input to the voice device 2B of the user B (voice V2) and output from the speaker, the user B feels uncomfortable due to the difference in volume.

Therefore, the setting processor 114 matches the signal level of the voice Vb2 output from the speaker of the voice device 2B (loopback voice) with the signal level of the voice V2 output from the speaker of the voice device 2B (remote location voice). For example, the setting processor 114 may make the signal level of the voice Vb2 substantially equal to the signal level of the voice V2, or may make the signal level of the voice V2 substantially equal to the signal level of the voice Vb2.

According to the above-described configuration, in the voice device 2, the voice quality in a case where voices acquired through different routes (a loopback route and a network route) are output can be improved.

Examples 1 to 3 described above can be appropriately combined. The voice processing device 1 according to the present disclosure may include at least any one of the configurations of Examples 1 to 3.

In addition, in the voice processing system 100, the voice processing device 1 and the meeting terminal 3 may be constituted by one device. For example, the voice processing device 1 may have a function of the meeting terminal 3 (such as a meeting application) and may be configured to be able to perform data communication with the meeting server 4.

The voice processing system of the present disclosure may be constituted by the voice processing device 1 alone, or may be constituted by a combination of the voice processing device 1, the plurality of voice devices 2, the meeting terminal 3, and the meeting server 4.

### Supplementary Notes of Disclosure

Hereinafter, a summary of the disclosure extracted from the above-described embodiments will be described as supplementary notes. The configurations and processing functions described in the following supplementary notes can be selected, omitted, and appropriately combined.

### Supplementary Note 1

A voice processing system that controls voices of a plurality of voice devices arranged in the same space, including:
an acquisition processor that acquires a first voice input to a microphone of a first voice device; and
a setting processor that enables or disables a function of outputting the first voice from speakers of one or more other second voice devices for each of the second voice devices.

### Supplementary Note 2

The voice processing system according to Supplementary Note 1, further including:
a specification processor that specifies a type of each of the voice devices, in which
the setting processor enables or disables the function of a target second voice device of the second voice devices on the basis of the type of the target second voice device.

### Supplementary Note 3

The voice processing system according to Supplementary Note 2, in which
the specification processor determines whether each of the voice devices is of a closed type in which ears of a user are closed during use or of an open type in which the ears of the user are not closed during use, and
the setting processor enables the function when the target second voice device is of the closed type and disables the function when the target second voice device is of the open type.

### Supplementary Note 4

The voice processing system according to Supplementary Note 2 or 3, in which
the setting processor sets a signal level of the speaker of the target second voice device on the basis of the type of the target second voice device.

### Supplementary Note 5

The voice processing system according to any one of Supplementary Notes 1 to 4, in which
the setting processor enables or disables the function of the target second voice device in accordance with a setting operation of a user.

### Supplementary Note 6

The voice processing system according to any one of Supplementary Notes 2 to 5, in which,
when the target second voice device is connected, the setting processor acquires the type associated with identification information of the target second voice device from a storage that stores identification information of each of the voice devices and the type of each of the voice devices in association with each other, and enables or disables the function of the target second voice device on the basis of the acquired type.

### Supplementary Note 7

The voice processing system according to Supplementary Note 6, in which,
when the target second voice device is connected and the type of the target second voice device is not stored in the storage, an inquiry about the type of the target second voice device is made, and the type of the target second voice device is stored in the storage when being acquired.

### Supplementary Note 8

The voice processing system according to any one of Supplementary Notes 1 to 7, in which
the acquisition processor acquires a second voice input to a microphone of a voice device arranged in a space different from the space, and
the setting processor matches a signal level of the first voice output from the speaker of a target second voice device of the second voice devices with a signal level of the second voice output from the speaker of the target second voice device.

What is claimed is:

1. A voice processing system that controls voices of a plurality of voice devices arranged in a same space, comprising:
an acquisition processor that acquires a first voice input to a microphone of a first voice device; and
a setting processor that enables or disables a function of outputting the first voice from speakers of one or more other second voice devices for each of the second voice devices.

2. The voice processing system according to claim 1, further comprising:
a specification processor that specifies a type of each of the voice devices, wherein
the setting processor enables or disables the function of a target second voice device of the second voice devices on the basis of the type of the target second voice device.

3. The voice processing system according to claim 2, wherein
the specification processor determines whether each of the voice devices is of a closed type in which ears of a user are closed during use or of an open type in which the ears of the user are not closed during use, and
the setting processor enables the function when the target second voice device is of the closed type and disables the function when the target second voice device is of the open type.

4. The voice processing system according to claim 2, wherein
the setting processor sets a signal level of the speaker of the target second voice device on the basis of the type of the target second voice device.

5. The voice processing system according to claim 1, wherein
the setting processor enables or disables the function of the target second voice device in accordance with a setting operation of a user.

6. The voice processing system according to claim 2, wherein,
when the target second voice device is connected, the setting processor acquires the type associated with identification information of the target second voice device from a storage that stores identification information of each of the voice devices and the type of each of the voice devices in association with each other, and enables or disables the function of the target second voice device on the basis of the acquired type.

7. The voice processing system according to claim 6, wherein,
when the target second voice device is connected and the type of the target second voice device is not stored in the storage, an inquiry about the type of the target second voice device is made, and the type of the target second voice device is stored in the storage when being acquired.

8. The voice processing system according to claim 1, wherein
the acquisition processor acquires a second voice input to a microphone of a voice device arranged in a space different from the space, and
the setting processor matches a signal level of the first voice output from the speaker of a target second voice device of the second voice devices with a signal level of the second voice output from the speaker of the target second voice device.

9. A voice processing method for controlling voices of a plurality of voice devices arranged in a same space, the voice processing method causing one or more processors to execute:
acquiring a first voice input to a microphone of a first voice device; and
enabling or disabling a function of outputting the first voice from speakers of one or more other second voice devices for each of the second voice devices.

10. A non-transitory computer-readable medium storing a voice processing program that controls voices of a plurality of voice devices arranged in a same space, the voice processing program causing one or more processors to execute:
acquiring a first voice input to a microphone of a first voice device; and
enabling or disabling a function of outputting the first voice from speakers of one or more other second voice devices for each of the second voice devices.
